(19) United States
(12) Patent Application Publication
(10) Pub. No.: US 2022/0198222 A1
(43) Pub. Date: Jun. 23, 2022

(54) AUTOMATED GENERATION OF MACHINE LEARNING MODEL PIPELINE COMBINATIONS

(71) Applicant: International Business Machines Corporation, Armonk, NY (US)

(72) Inventors: Ambrish Rawat, Dublin (IE); Martin Wistuba, Dublin (IE)

(21) Appl. No.: 17/125,918

(22) Filed: Dec. 17, 2020

(51) Int. Cl. G06K 9/62; G06F 9/38; G06N 20/20; G06F 8/41

(52) U.S. Cl. CPC G06K 9/6257; G06F 8/4452; G06N 20/20; G06F 9/3891

(57) ABSTRACT

A computer receives a dataset and a set of ML pipeline components to generate a preferred ensemble of Machine Learning (ML) pipelines. An Automated Learning (AutoML) tool is applied to generate a plurality of ML pipelines. A performance value is determined for each pipeline, and a set of candidate pipelines is identified based on the performance values. The candidate pipelines are combined into candidate ensembles. A database provides historic performance data for a plurality of historic ensembles applied to a plurality of historic datasets. A metamodel is trained to identify patterns within the historic performance data, and a applies the patterns to generate predicted ensemble performance values for the candidate ensembles. A preferred ensemble is selected based on the predicted performance value rankings.

### BACKGROUND

The present invention relates generally to the field of automated machine learning, and more specifically, to generating ensembles of machine learning pipelines.

Artificial Intelligence (AI) systems often use Machine Learning (ML) models to provide responses to stimuli that approximate traditional human reactions. ML model performance can vary based on many associated parameters (e.g., hyperparameter settings, dataset classification features, and preprocessing tasks) selected and adjusted to optimize the effectiveness of a given model to provide expected responses for a given dataset. Although acceptable model performance may be achieved by tailoring model parameters for a particular set of data, it is possible to achieve better performance for many datasets when several models and sets of parameters (e.g., pipelines) are combined in some manner as an ensemble. Unfortunately, which of the many ML models, hyperparameters values, and preprocessing tasks available to combine and in which manner to combine them can be difficult. Even when appropriate pipelines have been identified, many possible methods to combine them exist, and knowing how to combine pipelines in a manner that generate accurate results for a given dataset can be difficult to determine.

### SUMMARY

According to one embodiment, a computer implemented method to generate a preferred ensemble of machine learning pipelines includes receiving by a computer, a dataset from a dataset source, and a set of ML pipeline components from a pipeline component source. The computer applies an Automated Learning (AutoML) tool to the ML pipeline components to generate a group of ML pipelines. The computer determines a performance value for each of the ML pipelines for the dataset and identifying a set of candidate pipelines based on the performance values. The computer combines the set of candidate pipelines into a group of candidate ensembles using an ensemble generation technique. The computer accesses a database including historic performance data for a group of historic ensembles applied to a group of historic datasets. The computer trains a metamodel to identify patterns within the historic performance data and applies the patterns to generate predicted ensemble performance values for the candidate ensembles as applied to the dataset. The computer selects a preferred ensemble based on the predicted performance value rankings. According to other aspects of the invention, the computer trains and evaluates a top-k-ranked plurality of the preferred ensembles over portions of the dataset to determine top-k-ranked ensemble performance values based on associated validation losses generated during the evaluating of the top-k-ranked ensembles. The at least one preferred ensemble is an ensemble having a lowest validation loss. According to other aspects of the invention, the metamodel includes a reinforcement learning controller that generates a policy that determines edit-actions to increase a validation accuracy value of the pipelines in the top-k-ranked ensembles. According to other aspects of the invention, the computer modifies the pipelines in the top-k-ranked ensembles according to the policy, thereby generating a set of enhanced pipelines. According to other aspects of the invention, the computer processes the set of enhanced pipelines as ML candidate pipelines. According to other aspects of the invention, the pipeline performance values are determined, according to a predetermined performance metric selected from a list consisting of pipeline validation loss and pipeline training loss. According to other aspects of the invention, the ensemble generation technique is selected from a list consisting of pipeline averaging, pipeline boosting, pipeline bootstrap aggregating, pipeline majority vote, random forest, Bayesian optimal classification, and pipeline stacking. According to other aspects of the invention, the performance of the plurality of historic ensembles is based, at least in part, on a validation loss associated with the historic ensembles as applied to the historic datasets. According to other aspects of the invention, the computer adds ML pipeline candidate ensemble performance values to the historic ensemble performance database to increase the historic ensemble performance database content.

According to another embodiment, a system to generate a preferred ensemble of machine learning pipelines, includes a computer system comprising a computer readable storage medium having program instructions embodied therewith, the program instructions executable by a computer to cause the computer to: receive from a pipeline component source, ML pipeline components; apply an Automated Learning (AutoML) tool to the ML pipeline components to generate a plurality of ML pipelines; determine a performance value for each of the ML pipelines for the dataset and identifying a set of candidate pipelines based on the performance values; combine the set of candidate pipelines into a plurality of candidate ensembles using an ensemble generation technique; access a database including historic performance data for a plurality of historic ensembles applied to a plurality of historic datasets; train a metamodel to identify patterns within the historic performance data; apply the patterns to generate predicted ensemble performance values for the candidate ensembles as applied to the dataset; and select a preferred ensemble based on the predicted performance value rankings.

A computer program product to generate a preferred ensemble of machine learning pipelines, the computer program product comprising a computer readable storage medium having program instructions embodied therewith, the program instructions executable by a computer to cause the computer to: receive, using a computer, from a pipeline component source, ML pipeline components; apply, using the computer, an Automated Learning (AutoML) tool to the ML pipeline components to generate a plurality of ML pipelines; determine, using the computer, a performance value for each of the ML pipelines for the dataset and identifying a set of candidate pipelines based on the performance values; combine, using the computer, the set of candidate pipelines into a plurality of candidate ensembles using an ensemble generation technique; access, using the computer, a database including historic performance data for a plurality of historic ensembles applied to a plurality of historic datasets; train, using the computer, a metamodel to identify patterns within the historic performance data; apply, using the computer, the patterns to generate predicted ensemble performance values for the candidate ensembles as applied to the dataset; and select, using the computer, a preferred ensemble based on the predicted performance value rankings.

The present invention recognizes the benefits of an ensemble generation technique that learns from previous experiences. The present invention recognizes the benefits of using preferred pipelines, considering several ensemble strategies, using an ensemble evaluation metamodel trained on a history of ensemble performance, recommending pipeline enhancements, and considering the original and enhanced pipelines when selecting preferred ensembles. The present invention also recognizes the benefits of using customized combinations of models and tailored model parameters to improve AI performance.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for a computer-implemented method to generate a preferred ensemble of machine learning pipelines according to embodiments of the present invention.

FIG. 2 is a flowchart illustrating a method, implemented using the system shown in FIG. 1, of generating a preferred ensemble of machine learning pipelines according to aspects of the invention.

FIG. 3 is a schematic block diagram illustrating an alternate view of a system for a computer-implemented method to generate a preferred ensemble of machine learning pipelines according to embodiments of the present invention.

FIG. 4 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 5 depicts a cloud computing environment according to an embodiment of the present invention.

FIG. 6 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

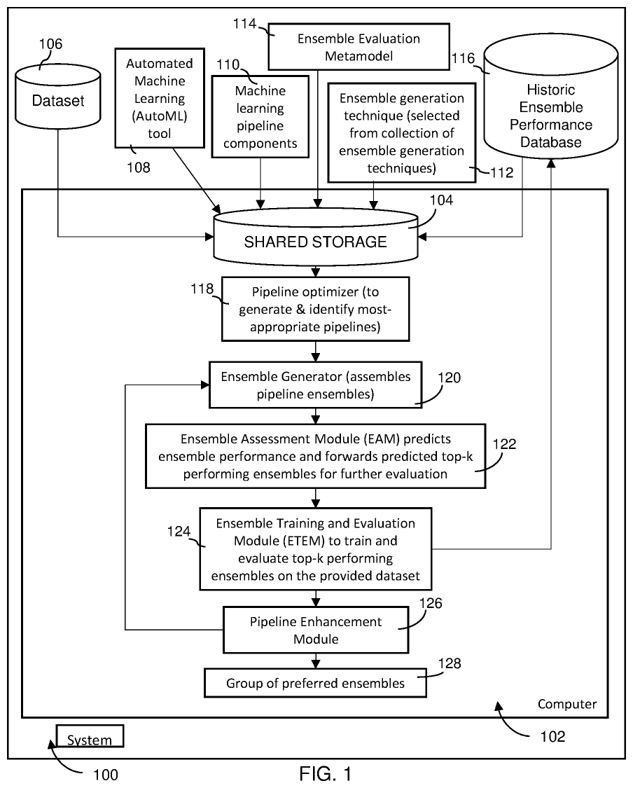

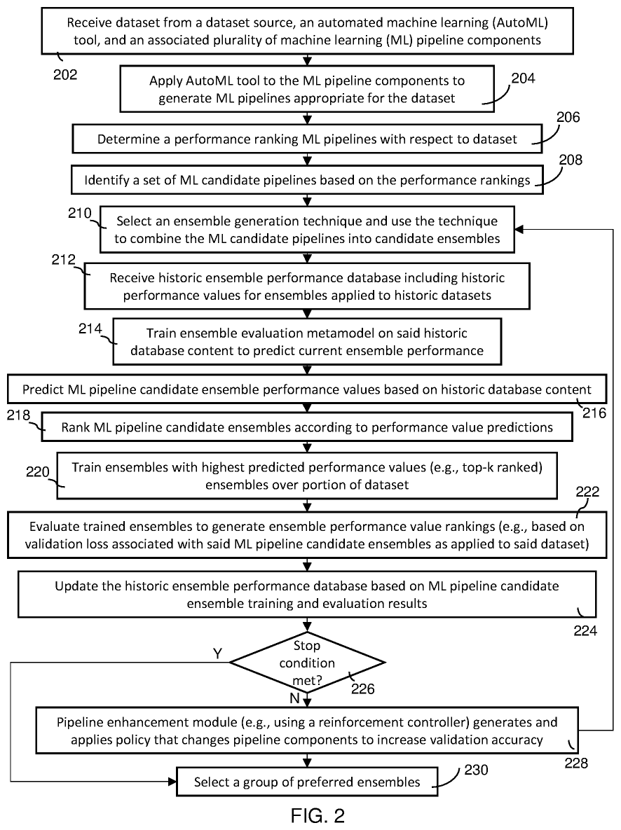

Now with combined reference to the Figures generally and with particular reference to FIG. 1 and FIG. 2, an overview of a method to generate a set of preferred pipeline ensembles that considers historic ensemble performance over historically similar data, as well as performance metrics for ensembles trained and evaluated over a selected dataset usable within a system 100 as carried out by a server computer 102 having optionally shared storage 104, according to an embodiment of the present disclosure is shown. The server computer 102 receives a dataset 106 that contains data suitable for training machine learning models (e.g., algorithms), as is known in this field. In one embodiment, the dataset contains fields of information, along with associated labels (e.g., training annotations) identifying the field contents. According to aspects of the invention, the dataset 106 may be provided by a user (e.g., through a file, user interface, or other source selected by one skilled in this field). The server computer 102 receives an Automated Machine Learning (AutoML) tool 108 from an AutoML tool source (not shown) for generating Machine Learning (ML) pipelines appropriate for the dataset 106 provided. As is known in this field, the AutoML tool 108 (e.g., an algorithm such as those discussed in the Tree-Based Pipeline Optimization Tool (TPOT), the scikit-learn machine learning library, and other similar tools known by those skilled in this field) automates the generation of ML pipelines (e.g., collections of machine learning components including learning model algorithms, hyperparameter settings, dataset classification features, and preprocessing methods or tasks) suited for the dataset 106 provided. The server computer 102 receives a set of ML pipeline components 110 (e.g., learning algorithm or model options, hyperparameter settings, dataset classification features, preprocessing methods or tasks, etc.) for use by the AutoML tool 108. The server computer 102 also receives an ensemble generation technique 112 from a method source (not shown). According to aspects of the invention, the ensemble generation technique 112 is one of several well-known approaches selected according to the judgement of one skilled in this field. Methods such as pipeline Bootstrap AGGregating (otherwise known as BAGGing), pipeline averaging, pipeline boosting, pipeline majority vote, random forest, Bayesian optimal classification, and pipeline stacking. It is noted that other known ensemble generation techniques can be selected as appropriate. The server computer 102 receives an Ensemble Evaluation Metamodel (EEM) 114 that is trained on reference content from a Historic Ensemble Performance Database (HEPD) 116 to predict ensemble performance. The HEPD 116 reference content includes historic performance metadata, including performance metrics for a plurality of historic ensembles applied previously to a corresponding plurality of historic datasets, along with feature metadata for the historic ensembles and historic datasets associated with the HEPD. The sever computer 102 includes a pipeline optimizer 118 that uses the AutoML tool 108 provided to generate and identify pipelines appropriate for the provided dataset 106. According to aspects of the invention, the AutoML tool discovers high performing pipelines with minimal user involvement. Although, according to aspects of the invention, the HEPD 116 is iteratively updated with input from the Ensemble Assessment Module (EAM) 122 described more fully below, it is noted that the HEPD may contain a large and varied, static set of previously-collected information that is not updated.

The server computer 102 includes an Ensemble Generator 120 that, according to aspects of the invention, will combine several ML pipelines together in a manner defined by the ensemble generation technique 112 selected to provide optimal performance on the provided dataset 106. The sever computer 102 includes an Ensemble Assessment Module (EAM) 122 that predicts ensemble performance, using the metamodel, and ranks ensembles by predicted performance. The sever computer 102 also includes an Ensemble Training and Evaluation Module (ET EM) 124 to train and evaluate a highest top-k performing ensembles on the provided dataset 106. The sever computer 102 also includes Pipeline Enhancement Module 126 that includes aspects (e.g., a reinforcement learning controller that generates and applies a positive reward seeking policy) to change pipeline component as a way to increase pipeline validation accuracy. According to aspects of the invention, the sever computer 102 selects a group of preferred ensembles 128 based on a preselected performance metric (e.g., validation loss) of the ensembles generated by ensemble generator 120 and ranked by EAM 122, as applied to the dataset 106 provided.

Now with particular reference to FIG. 2, the method of the present invention will be discussed. The server computer 102 receives a dataset 106 from a dataset source, an Automated Machine Learning (AutoML) tool 108, and an associated plurality of Machine Learning (ML) pipeline components 110.

The server computer 102 applies via pipeline optimizer 118 at block 204, the AutoML tool to the ML pipeline components to generate ML pipelines appropriate for the dataset 106. In particular, the AutoML tool 108, is an ML model trained using methods known to those skilled in this field, to select pipeline components (e.g., appropriate learning models, preprocessing routines, and related hyperparameters) optimized for use with various datasets. According to aspects of the invention, the server computer 102 uses the pipeline optimizer 118 to find pipeline components especially well-suited for the current dataset 106.

The server computer 102 determines at block 206, via the pipeline optimizer 118, a performance value of the generated ML pipelines with respect to dataset 106. According to aspects of the invention, the performance value is based on respective validation losses determined for each pipeline in a fashion known to those skilled in this field, as the pipelines are each applied to the dataset 106 provided. The server computer 102 then identifies, through continued application of the pipeline optimizer 118 at block 208, a set of ML candidate pipelines based on the associated performance values (e.g., respective pipeline validation loss or other similar metric selected by one of skill in this field). It is also noted that the AutoAI “Kaggle Bot” prepared by International Business Machines (IBM) is a suitable pipeline optimizer. According to aspects of the invention, the pipeline optimizer 118 builds basic machine learning pipelines and evaluates associated validation accuracy.

The server computer 102 selects at block 210, ensemble generation technique 112 from an ensemble technique collection and uses the method to combine the ML candidate pipelines into candidate ensembles suitable for the provided dataset 106. In particular, given the dataset 106 and pipelines generated in the pipeline optimizer 118, the sever computer 102, via the ensemble generator 120, suggests different ways to combine the ML candidate pipelines into a compound model that includes aspects of each of the candidate pipelines. According to aspects of the invention, preferred combination methods include pipeline averaging, pipeline boosting, pipeline bootstrap aggregating, pipeline majority vote, random forest, Bayesian optimal classification, and pipeline stacking. It is noted that ensemble generation techniques that consider ML candidate pipeline validation loss values may be used alone, or in combination with other methods, and the specific combination method or methods used to generate candidate ensembles may be selected in accordance with the judgment of a system designer skilled in this field. It is noted that, according to aspects of the present invention, the ensemble generator 120 may apply more than one ensemble generation techniques to produce a variety of candidate pipeline combinations.

The server computer 102 receives, at block 212, information from the HEPD 116 including historic performance metrics and feature metadata for a variety of ensembles applied to a variety of historic datasets. According to aspects of the invention, in order to determine an optimal combination of ML model pipelines (e.g., arranged as one or more ensembles) the server computer 102 uses historic information collected about previously applied ensembles to predict performance of currently generated ensembles. In particular, the EAM 122 receives a history of previous ensemble learning experiences, including ensemble feature metadata and associated historic dataset metadata from the HEPD 116. According to aspects of the invention, the content of the HEPD 116 increases with each round of ensemble selection, as the server computer 102 adds performance results via pipeline enhancement module 126 (described more fully below) to update the HEPD content. These updates allow the HEPD 116 to provide enhanced predication capability as more and more ensembles 128 are evaluated. According to aspects of the invention, the HEPD 116 stores information (e.g., reference content) regarding the previously-used ensembles and ensemble performance with various datasets. The HEPD 116 contains information that allows the EAM 122 to predict (as described more fully below) the performance of ensembles generated by the ensemble generator 120 as applied to datasets similar to the current dataset 106, by referencing the historic performance of similar ensembles. In particular, the HEPD 116 includes historic ensemble metadata used by the server computer 102 (via EEM 114) to determine a similarity comparison between previously used ensembles and ensembles provided by ensemble generator 120. The HEPD 116 similarly contains historic dataset metadata that allows the server computer 102 to determine a similarity comparison between previously used datasets and the currently-provided dataset 106.

According to aspects of the invention, one approach for determining similar ensembles is to compare feature vectors (e.g., attribute embeddings) associated with current ensembles to feature features of historic ensembles, using information (e.g., ensemble metadata) stored in the HEPD 116. As used herein, the concept of ensembles that are “similar” means, for example, ensembles with a feature embedding cosine similarity of 95% or higher. Other cosine similarity values (as well as other measuring arrangements) could be chosen by one skilled in this field. If similar ensembles are identified, the EAM 122 uses historic performance of the similar ensembles with various datasets to predict performance of the current, similar ensembles. In particular, the EAM 122 receives ensembles from the ensemble generator 120 as input, determines performance (via, e.g., EEM 114) of the received ensembles (e.g., “run models 2, 3, & 5 and provide an average of their predictions”) on datasets similar to the dataset 106 currently provided, and provides performance information for the various ensembles as output. Through this approach, the server computer 102 has access to a database (e.g., the HEPD 116) of historic ensemble performance that includes information about which ensembles have been the best performers with certain datasets (which pipelines fit the data best). The server computer 102, receives an EEM 114 and trains the EEM with content from the HEPD 116 to predict ensemble performance. The server computer 102 via the EEM 114 at block 214, compares the candidate ensembles from the Ensemble Generator 120 and current dataset 106 to HEPD metadata content for historic ensembles and historic datasets and predicts, at block 216, candidate ensemble performance based on HEPD 116 content.

According to aspects of the invention, the EAM 122 ranks candidate ensembles, at block 218, according to predicted performance over the provided dataset 106. For example, the EEM 114 can, in one embodiment, be a surrogate model used by the server computer to predict, at block 216, validation accuracies of candidate ensembles and then to rank them at block 218. The server computer 102 uses EEM 114 to score the performance of each ensemble generated by the ensemble generator 120, with higher scores indicating a higher confidence that the scored ensemble will give satisfactory results with the provided dataset. According to aspects of the invention, EEM 114 includes an algorithm optimized to rank and predict ensembles of machine learning pipelines. According to aspects of the invention, the EAM 122 (including, e.g., the EEM 114) advantageously applies a historical perspective from information in the HEPD 116 to give recommendations regarding which ensembles are most likely to perform best with a certain scenario. According to aspects of the invention, the EEM 114 is trained on performance information associated with many historic ensemble and dataset pair datapoints. Using the performance information, the EEM 114 identifies patterns within the performance of various historic ensemble and dataset pairs to predict the likely performance of each ensemble provided by the ensemble generator 120.

One prediction model applied by the EEM 114 is to identify which historic ensembles are most similar to the currently generated ensembles (e.g., those provided by the ensemble generator 120), to identify the performance information (e.g., performance values from HEPD 116 metadata content) associated with the historic ensembles as applied to historic datasets most similar to the current dataset 106, and to assign the performance values of the historic ensembles most similar to current ensembles as the predicted performance values of the various current ensembles. Other machine learning arrangements to train the EEM 114 to identify historic performance values of various historic ensembles applied to various historic datasets may also suffice and alternate methods to train the EEM 114 to predict current ensemble performance may be selected by those skilled in this field.

The server computer 102, via Ensemble Training and Evaluation Module (ETEM) 124 trains, at block 220, a top-k performing candidate ensembles on a training portion of the provided dataset 106, and then generates an evaluated ensemble performance values for each ensemble as applied to an evaluation portion of the provided dataset. It is noted strategic selection of the value for “k” allows the present invention to strike a balance between overall accuracy and efficiency. In particular, the k value may be chosen according to a variety of factors (e.g., available processing speed, total number of candidate ensembles generated, etc.) and may be selected within the judgment of designer skilled in this field. According to aspects of the invention, an acceptable value for “k” is 10% of the total number of candidate ensembles generated. With this approach, the server computer 102 moves beyond mere prediction and beneficially determines actual performance for top-ranked ensembles.

The ETEM 124 evaluates, at block 222, the trained ensembles to generate ensemble performance metric rankings. One preferred performance metric is validation loss associated with the ML pipeline candidate ensembles as applied to the provided dataset 106, although other performance metric ranking values may be selected in accordance with the judgment of one skilled in this field. According to aspects of the invention, cooperation between the EEM 114 and ETEM 124 improves efficiency and accuracy of preferred ensemble selection. In particular, the EEM 114 downselects ensembles with a historically-indicated likelihood of high performance for the current dataset from among all ensembles generated by the ensemble generator 120 and passes only those candidate ensembles to the ETEM 124 for further processing, wherein actual ensemble performance is determined. By sending only a downselected subset of all generated ensembles to the ETEM 124, the EEM reduces 114 reduces the processing burden placed on the server computer 102 during ETEM training and subsequent ensemble evaluation. With this combination, embodiments of the present invention produces efficient and accurate preferred ensemble selections.

To increase the system 100 prediction accuracy, general performance, and thus improve system efficiency and success at finding high-performing ensembles over time, the server computer 102, updates the HEPD 116 content at block 224 with training and evaluation data from the EAM 122. For example, according to aspects of the invention, the server computer 102 updates the HEPD 116 with ML pipeline candidate and dataset metadata, ensemble training results, and evaluation performance metrics. Other information may be provided to update the HEPD 116 in accordance with the judgment of one skilled in this field.

According to aspects of the invention, the EEM 114 is trained to recommend updates to candidate ensembles and to suggest new ensemble pipelines based on content of the HEPD 116. It is also noted that, according to aspects of the invention, the EEM 114 can be a Reinforcement Learning (RL) controller that, at block 228, predicts a policy which determines the edit-actions required to change the candidate pipelines to generate a maximum reward, as is known in this field, and to subsequently rank the set of enhanced pipelines according to a validation accuracy value generated, for example, with regard to the provided dataset. According to aspects of the invention, the set of enhanced pipelines is passed to block 210, for consideration by the ensemble generator when selecting which ML candidate pipelines to include in candidate ensembles.

According to aspects of the invention, the candidate ensemble updating may be conducted iteratively or as a batch. When conducted iteratively, the server computer looks, at block 226, for a stop condition (such as, nor further significant performance improvement noted, or a preselected number of update cycles has been completed, etc.) to be satisfied before a round of updates is conducted. As used herein, the phrase “significant performance improvement” refers to a change in measured performance greater than or equal to 10%, although other values could be selected in accordance with the judgment of one skilled in this field. An acceptable number of update cycles is 10, although other numbers may be selected in accordance with available computing time or available resources according to the judgment of one skilled in this field.

According to aspects of the invention, the server computer 102, at block 230, selects at least one preferred ensemble. In one embodiment, the preferred ensemble selection is based on ML pipeline candidate ensemble predicted performance value ranking.

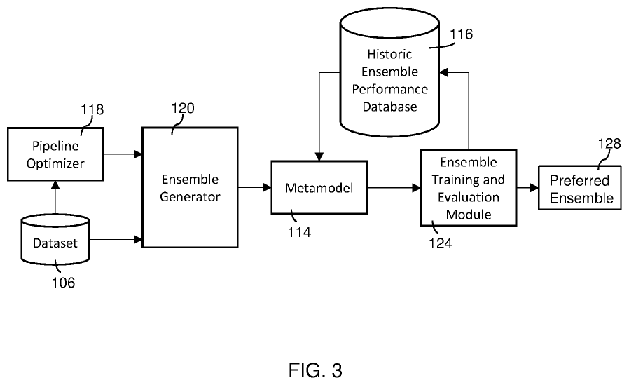

With reference to FIG. 3, an alternate view of selected components from the system 100 is shown. According to aspects of the invention, the system 100 receives a dataset 106 and over the course of the flow shown in FIG. 3, makes a recommendation about which of several customized pipeline ensembles will provide the best performance with the data provided in dataset 106.

With continued reference to FIG. 3, the server computer 102 receives a dataset 106 appropriate for a given use case, and the portions of the dataset are fed to pipeline optimizer 118 and ensemble generator 120. According to aspects of the invention, pipeline optimizer 118 is an automated machine learning process (or other similar process) that identifies models suitable to provide predictions on the received dataset. The pipeline optimizer 118 is responsible for establishing appropriate pipeline components (including, for example, preprocessing steps, identifying key data features, and generating associated Machine Learning (ML) models) for use with the dataset 106. According to aspects of the invention, the pipeline optimizer 118 makes the selections described above to maximize prediction performance on the dataset, and the pipeline optimizer determines multiple such pipelines for use with the provided dataset 106.

With continued reference to FIG. 3, the pipeline optimizer 118 forwards the optimized pipelines to ensemble sampler 120 for further processing. It is noted that the performance of certain pipeline combinations provides better performance than that of any single (even optimized) pipeline for many datasets. According to aspects of the invention, the ensemble generator 120 suggests various combinations of optimized pipelines from among the pipelines received from the pipeline optimizer 118 as a way of providing performance even better than any single optimized pipeline. It is noted that the ensemble generator is not directly responsible for directly establishing the optimal pipeline combination for a given dataset. According to aspects of the invention, the ensemble generator 120 is merely establishing viable combinations for further evaluation downstream by the metamodel 114, and accordingly, many pipeline combination strategies could suffice to generate suitable pipeline combinations. For example, an ensemble combination strategy that computes an average of results from a predetermined number of highest performing number of pipelines might be selected in some cases. In other situations, a weighted mean of output from all optimized pipeline might be a chosen strategy. It is noted that application of these approaches are well suited for situations will low processing availability, because they do not require subsequent model training. Other, more advanced approaches, known as model stacking, are more computationally intensive and, for some datasets, provide more desirable results. Stacking strategies typically use the output of a set of optimized pipelines to make predictions on portions of the provided data, and then using the predictions as a new dataset on which a new ML model is trained. This stacking arrangement could, for example, involve passing output from random forest ensemble into a decision tree model. Stacked ensemble models can provide more refined predictions than those available with direct application of single-layer pipeline combinations.

With continued reference to FIG. 3, the various pipeline combinations generated by the ensemble generator 120 are passed along to metamodel 114 for further consideration. It is noted that determining a preferred ensemble of pipelines can be computationally expensive, and aspects of the present invention cooperatively reduce the time necessary to identify a preferred ensemble. To efficiently choose from among possible pipeline combinations (i.e., ensembles), aspects of the present invention provide a complementary optimization process that improves ensemble selection efficiency by applying historic performance data from Historic Ensemble Performance Database (HEPD) 116 for datasets similar to the currently provided dataset 106. In particular, the HEPD 116 contains a large collection of information about which ensembles were high performers for datasets having certain noted characteristics. The metamodel 114 is trained on this information to make ensemble performance recommendations, and in turn, to rank expected ensemble performance for a wide array of dataset types.

According to aspects of the invention, the metamodel 114 identifies similarities between current dataset characteristics (e.g., notable features identified as dataset metafeatures) and various datasets documented in the HEPD 116. Based on similarity to historic models, the trained metamodel 114 identifies which ensembles have historically produced positive results when applied to datasets having characteristics similar to those of the current dataset.

With continued reference to FIG. 3, the metamodel 114 passes selected ensembles (e.g., ensembles predicted to be high performers) along to the Ensemble Training and Evaluation Model (ETEM) 124, which evaluates current ensemble performance using training and evaluation portions of the provide dataset 106. This performance data is added to the HEPD 116 to increase the database scope of coverage. The metamodel 114 is also trained with performance data from the ETEM 124, and this ongoing training further improves metamodel 114 ensemble performance prediction accuracy. With access to historical perspective from the HEPD 116, the 114 metamodel improves ensemble recommendation efficiency by focusing training efforts in the ETEM 124 on pipeline combinations predicted to provide exceptional performance with the provided dataset 106. According to aspects of the invention, the metamodel 114 can predict ensemble performance for various datasets and also suggest updates to suggested ensembles and also suggest new ensemble pipelines based on information stored from previous ensemble performance over many different datasets.

With continued reference to FIG. 3, the system of the present invention iteratively evaluates (e.g., in ETEM 1124), suggested ensemble candidates, updates the HEPD 116 and providing incremental metamodel 114 training with each round of evaluation. According to aspects of the invention, this iterative loop continues until a predetermined stop condition is present. Two preferred stop conditions include the passing of a predetermine amount of evaluation resources (e.g., a certain amount of computation time, etc.) having been spent and the arrival of an ensemble performance. When these (or similar stop condition selected by one skilled in this field), stop conditions exit, the current top performing ensemble is identified as a preferred ensemble recommendation 128.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

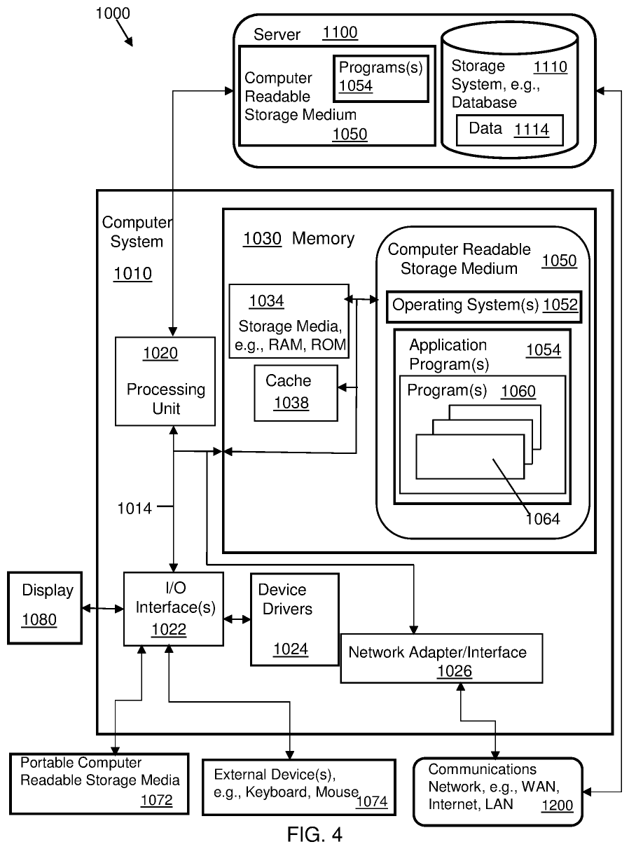

Referring to FIG. 4, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 8) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

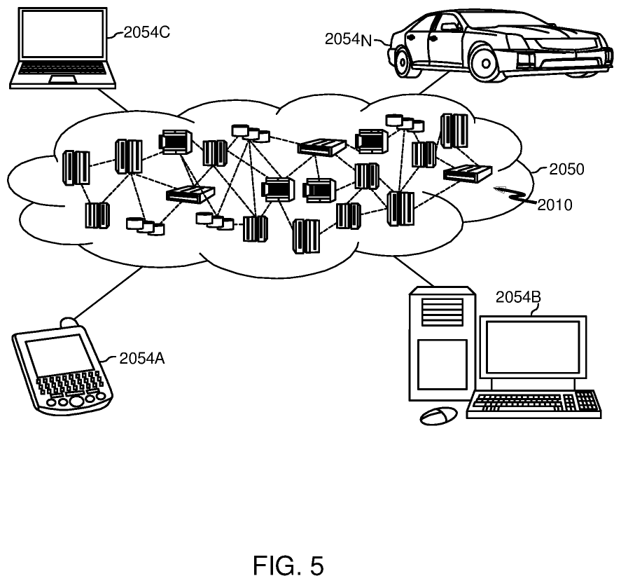

Referring now to FIG. 5, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

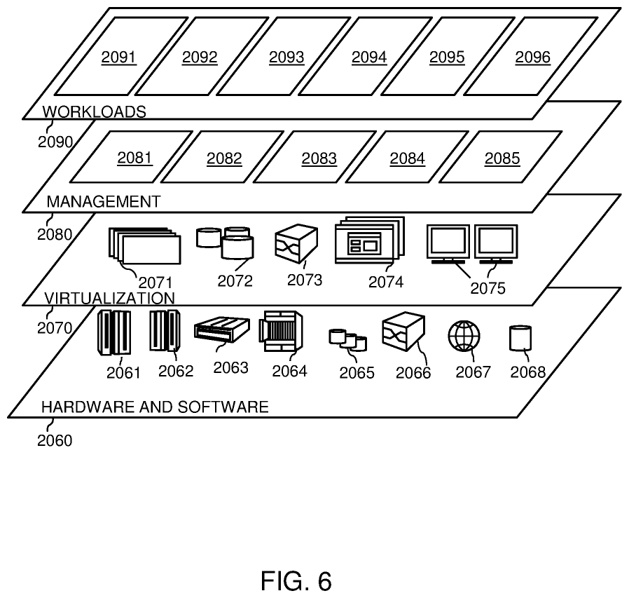

Referring now to FIG. 6, a set of functional abstraction layers provided by cloud computing environment 2050 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and generating a set of preferred pipeline ensembles 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method to generate a preferred ensemble of Machine Learning (ML) pipelines, comprising:
receiving by a computer, a dataset from a dataset source, and a set of ML pipeline components from a pipeline component source;
applying, by a computer, an Automated Learning (AutoML) tool to the ML pipeline components to generate a plurality of ML pipelines;
determining, by the computer, a performance value for each of the ML pipelines for the dataset and identifying a set of candidate pipelines based on the performance values;
combining, by the computer, the set of candidate pipelines into a plurality of candidate ensembles using an ensemble generation technique;
accessing, by the computer, a database including historic performance data for a plurality of historic ensembles applied to a plurality of historic datasets;
training, by the computer, a metamodel to identify patterns within the historic performance data;
applying, by the computer, the patterns to generate predicted ensemble performance values for the candidate ensembles as applied to the dataset; and
selecting, by the computer, a preferred ensemble based on the predicted performance value rankings.

2. The method of claim 1, further comprising:
Training and evaluating, by the computer, a top-k-ranked plurality of the preferred ensembles over portions of the dataset to determine top-k-ranked evaluated ensemble performance values based, at least in part, on associated validation losses generated during the evaluating of the top-k-ranked ensembles; and
wherein the at least one preferred ensemble is an ensemble having a lowest validation loss.

3. The method of claim 2, wherein the metamodel comprises:
a reinforcement learning controller that generates a policy that determines edit-actions to increase a validation accuracy value of the pipelines in the top-k-ranked ensembles;
modifying, by the computer, the pipelines in the top-k-ranked ensembles according to the policy, thereby generating a set of enhanced pipelines; and
wherein the computer processes the set of enhanced pipelines as ML candidate pipelines.

4. The method of claim 1, wherein the pipeline performance values are determined, at least in part, according to a predetermined performance metric selected from a list consisting of pipeline validation loss and pipeline training loss.

5. The method of claim 1, wherein the ensemble generation technique is selected from a list consisting of pipeline averaging, pipeline boosting, pipeline bootstrap aggregating, pipeline majority vote, random forest, Bayesian optimal classification, and pipeline stacking.

6. The method of claim 1, wherein the performance of the plurality of historic ensembles is based, at least in part, on a validation loss associated with the historic ensembles as applied to the historic datasets.

7. The method of claim 1, further comprising:
adding, by the computer, the ML pipeline candidate evaluated ensemble performance values to the historic ensemble performance database to increase the historic ensemble performance database content.

8. A system to generate a preferred ensemble of Machine Learning (ML) pipelines, which comprises:
a computer system comprising a computer readable storage medium having program instructions embodied therewith, the program instructions executable by a computer to cause the computer to:
receive from a pipeline component source, ML pipeline components;
apply an Automated Learning (AutoML) tool to the ML pipeline components to generate a plurality of ML pipelines;
determine a performance value for each of the ML pipelines for the dataset and identifying a set of candidate pipelines based on the performance values;
combine the set of candidate pipelines into a plurality of candidate ensembles using an ensemble generation technique;
access a database including historic performance data for a plurality of historic ensembles applied to a plurality of historic datasets;
train a metamodel to identify patterns within the historic performance data;
apply the patterns to generate predicted ensemble performance values for the candidate ensembles as applied to the dataset; and
select a preferred ensemble based on the predicted performance value rankings.

9. The system of claim 8 further comprising instructions causing the computer to:
train and evaluate a top-k-ranked plurality of the preferred ensembles over portions of the dataset to determine top-k-ranked evaluated ensemble performance values based, at least in part, on associated validation losses generated during the evaluating of the top-k-ranked ensembles; and
wherein the at least one preferred ensemble is an ensemble having a lowest validation loss.

10. The system of claim 9, wherein the metamodel comprises:
a reinforcement learning controller that generates a policy that determines edit-actions to increase a validation accuracy value of the pipelines in the top-k-ranked ensembles;
instructions causing the computer to modify the pipelines in the top-k-ranked ensembles according to the policy, thereby generating a set of enhanced pipelines; and
instructions causing the computer to process the set of enhanced pipelines as ML candidate pipelines.

11. The system of claim 8, wherein the pipeline performance values are determined, at least in part, according to a predetermined performance metric selected from a list consisting of pipeline validation loss and pipeline training loss.

12. The system of claim 8, wherein the ensemble generation technique is selected from a list consisting of pipeline averaging, pipeline boosting, pipeline bootstrap aggregating, pipeline majority vote, random forest, Bayesian optimal classification, and pipeline stacking.

13. The system of claim 8,
wherein the performance of the plurality of historic ensembles is based, at least in part, on a validation loss associated with the historic ensembles as applied to the historic datasets.

14. The system of claim 8, further comprising instructions causing the computer to:
add the ML pipeline candidate evaluated ensemble performance values to the historic ensemble performance database to increase the historic ensemble performance database content.

15. A computer program product to generate a preferred ensemble of Machine Learning pipelines, the computer program product comprising a computer readable storage medium having program instructions embodied therewith, the program instructions executable by a computer to cause the computer to:
receive, using a computer, from a pipeline component source, ML pipeline components;
apply, using the computer, an Automated Learning (AutoML) tool to the ML pipeline components to generate a plurality of ML pipelines;
determine, using the computer, a performance value for each of the ML pipelines for the dataset and identifying a set of candidate pipelines based on the performance values;
combine, using the computer, the set of candidate pipelines into a plurality of candidate ensembles using an ensemble generation technique;
access, using the computer, a database including historic performance data for a plurality of historic ensembles applied to a plurality of historic datasets;
train, using the computer, a metamodel to identify patterns within the historic performance data;
apply, using the computer, the patterns to generate predicted ensemble performance values for the candidate ensembles as applied to the dataset; and
select, using the computer, a preferred ensemble based on the predicted performance value rankings.

16. The computer program product of claim 15 further comprising instructions causing the computer to:
train and evaluate, using the computer, a top-k-ranked plurality of the preferred ensembles over portions of the dataset to determine top-k-ranked evaluated ensemble performance values based, at least in part, on associated validation losses generated during the evaluating of the top-k-ranked ensembles; and
wherein the at least one preferred ensemble is an ensemble having a lowest validation loss.

17. The computer program product of claim 16, wherein the metamodel comprises:
a reinforcement learning controller that generates a policy that determines edit-actions to increase a validation accuracy value of the pipelines in the top-k-ranked ensembles;
instructions causing the computer to modify, using the computer, the pipelines in the top-k-ranked ensembles according to the policy, thereby generating a set of enhanced pipelines; and
instructions causing the computer to process the set of enhanced pipelines as ML candidate pipelines.

18. The computer program product of claim 15, wherein the pipeline performance values are determined, at least in part, according to a predetermined performance metric selected from a list consisting of pipeline validation loss and pipeline training loss.

19. The computer program product of claim 15, wherein the ensemble generation technique is selected from a list consisting of pipeline averaging, pipeline boosting, pipeline bootstrap aggregating, pipeline majority vote, random forest, Bayesian optimal classification, and pipeline stacking.

20. The computer program product of claim 15, further comprising instructions causing the computer to:
add the ML pipeline candidate evaluated ensemble performance values to the historic ensemble performance database to increase the historic ensemble performance database content.
